(19) United States
(12) Patent Application Publication
(10) Pub. No.: US 2011/0102690 A1
(43) Pub. Date: May 5, 2011

(54) LIQUID CRYSTAL DISPLAY PANEL AND LIQUID CRYSTAL DISPLAY DEVICE

(76) Inventors: Ryo Kikuchi, Osaka (JP); Hiroshi Fukushima, Osaka (JP); Tomoo Takatani, Osaka (JP)

(21) Appl. No.: 13/001,289

(22) PCT Filed: Apr. 9, 2009
(86) PCT No.: PCT/JP2009/057288

§ 371 Date: Dec. 23, 2010

(30) Foreign Application Priority Data
Jun. 24, 2008 (JP) 2008-164912

(51) Int. Cl. G02F 1/1335; G02B 27/26

(52) U.S. Cl. 349/15; 359/465

(57) ABSTRACT

A liquid crystal display panel 1 for displaying non-identical images along non-identical lines of sight includes: a parallax barrier (2) having light-transmitting sections (21) and light-blocking sections (22) alternately arranged in a lattice manner with each of the light-transmitting sections (21) provided with a condenser lens (23) having a long axis parallel to a long side A of the light-transmitting section (21); and a back polarizing plate (4) and a front polarizing plate (5) disposed on a light incidence side and a light exit side, respectively, each of the polarizing plates (4, 5) having its absorption axis set in a parallel or orthogonal relationship with the long axis of the condenser lens (23). This provides: a liquid crystal display panel capable of presenting non-identical images along non-identical lines of sight with high contrast; and a liquid crystal display device including such a liquid crystal display panel.

### TECHNICAL FIELD

The present invention relates to: a display panel capable of presenting non-identical images along non-identical lines of sight by including a parallax barrier; and a display device including such a display panel.

### BACKGROUND ART

A parallax barrier system is known as a system in which a two-dimensional image display device is used to show a stereoscopic image to a viewer or a two-dimensional image display device is used to display different images to a plurality of viewers. Further, the former display device, which shows a stereoscopic image to a viewer, is sometimes called “3D display device”, and the latter display device, which displays different images to a plurality of viewers, is sometimes called “multiview display device”.

For example, as shown in FIG. 13, Patent Literature 1 listed below discloses a dual-view display device 500 including a parallax barrier element 510, a liquid crystal display panel 520, and a backlight 530.

More specifically, the liquid crystal display panel 520 includes a lower substrate 521, an upper substrate 522, and a liquid crystal layer 523 sandwiched between the upper and lower substrates 522 and 521. Further, the lower substrate 521 is provided with TFTs (thin-film transistors) for switching on and off driving of pixels, pixel electrodes, etc., and the upper substrate 522 is provided with a color filter (hereinafter abbreviated as “CF”) 524, a black matrix 525, etc.

The parallax barrier element 510 has a plurality of light-blocking sections 501 and a plurality of light-transmitting sections 502 alternately disposed on a glass substrate 503. The parallax barrier element 510 is directly attached to the upper substrate 522 through a resin layer 505.

Furthermore, there is provided a pair of polarizing plates 541 and 542, respectively, on such that side of the lower substrate 521 which faces the backlight 530 and that side of the glass substrate 503 which faces a viewer.

Thus configured, the liquid crystal display panel 520 has a first pixel group for displaying a first image and a second pixel group for displaying a second image, and separation by the parallax barrier element 510 of display light emitted from the first pixel group and display light emitted from the second pixel group allows a plurality of viewers to view different images.

In Patent Literature 1, the action of the parallax barrier element 510 is described in detail with reference to FIG. 14. In the display device including the parallax barrier element 510, as shown in (a) and (b) of FIG. 14, there exist a region A that is within the reach of only display light from pixels P1 belonging to the first pixel group, a region B that is within the reach of only display light from pixels P2 belonging to the second pixel group, and a region C that is within the reach of both the display light from the pixels P1 and the display light from the pixels P2.

It should be noted that the region C is also called “crosstalk region” because in the region C a mixture of the two kinds of display light makes it difficult to view a normal image. As evidenced by making a comparison between (a) and (b) of FIG. 14, the region C can be narrowed and the regions A and B can be widened accordingly simply by narrowing the width of each of the light-transmitting sections 502 of the parallax barrier element 510.

However, because narrowing the width of each of the light-transmitting sections 502 is nothing but widening the width of each of the light-blocking sections 501, widening the regions A and B by narrowing the width of each of the light-transmitting sections 502 leads to a decrease in display luminance and therefore a dark image.

Accordingly, Patent Literature 1 discloses a configuration to solve the foregoing problems, i.e., a display device 600 devised so that the region C can be narrowed while a bright display is allowed by widening the width of each of the light-transmitting sections 502.

As shown in FIG. 15, the display device 600 has lenses 504 provided in the light-transmitting sections 502, respectively, and each of the lenses 504 has a function of condensing light toward a viewer. Specifically, each of the lenses 504 is a convex lens having a predetermined curvature radius, e.g., a semi-cylindrical lenticular lens.

This makes it possible for light having passed through the CF 524 to be condensed by each of the lenses 504 toward the front as shown in FIG. 16, with the result that a luminance distribution (range indicated by a solid line in FIG. 16) of the display light from the pixels P1 and a luminance distribution (range indicated by a dotted line in FIG. 16) of the display light from the pixels P2 become narrower as seen from the front and, accordingly, the region C, which is a region of overlap between the luminance distributions, becomes narrower.

### Citation List

Patent Literature 1

International Publication No. WO 2008/029891 (Publication Date: Mar. 31, 2008)

### SUMMARY OF INVENTION

### Technical Problem

However, in the configuration of the display device 600 disclosed in Patent Literature 1, no consideration is given for a relationship between the orientation of the polarization axis (absorption axis) of each of the polarizing plates 541 and 542 and the orientation of the long axis of each of the semi-cylindrical lenticular lenses, which are used as the lenses 504. For this reason, depending on how the orientation of the polarization axis and the orientation of the long axis are set, there occurs a problem of a decrease in display contrast.

(Axial Arrangement for Decreasing the Contrast)

As a result of their long years of study, the inventors found that in such a case as shown in (g), (h), and (i) of FIG. 2 where the liquid crystal display panel 520 has its polarizing plates 541 and 542 disposed on back and front sides thereof, respectively, so that their respective absorption axes are orthogonal to each other, there is a decrease in contrast when the polarization axis of each of the polarizing plates 541 and 542 and the long axis of each of the lenses 504 have angles that are neither parallel nor orthogonal to each other. It should be noted that reasons for this will be explained in detail later in comparison with the present invention in embodiments of the present invention.

(Relationship between the Orientation of Polarization Axes and a Display Mode)

There is a technical necessity in setting the polarization axis of each of the polarizing plates 541 and 542 so that the polarization axis of each of the polarizing plates 541 and 542 and the long axis of each of the lenses 504 have angles that are neither parallel nor orthogonal to each other. The following explains this point.

Twisted-nematic (hereinafter abbreviated as “TN”) liquid crystal display devices are used extensively in many fields such as display screens of cellular phones or digital cameras or comparatively larger-sized display screens of laptop personal computers, word processors, or monitoring display devices, etc. This is because TN liquid crystal display devices have excellent characteristics of being adapted to low voltage and low power and being satisfactory in display performance such as contrast.

However, a TN liquid crystal display device has such a defect that in cases where a display screen is viewed from a specific viewing angle with respect to a rubbing direction by which an alignment state of liquid crystal molecules is determined, a tone reversal region attributed to the alignment state of the liquid crystal molecules is seen in a comparatively wide range toward one side of the display screen.

For example, (a) of FIG. 8 shows rubbing directions of a liquid crystal display panel called a six o'clock viewing angle panel and a tone reversal region as viewed from a six o'clock viewing angle (viewing angle at which the display screen is viewed obliquely from below). In the six o'clock viewing angle panel, as shown in (a) of FIG. 8, the (TFT-side) rubbing direction of an alignment film provided on the lower substrate 521 is set to be 315 degrees and the (CF-side) rubbing direction of an alignment film provided on the upper substrate 522 is set to be 45 degrees. Note, however, that the rubbing directions are indicated by angles that are larger than one another anticlockwise, with the three o'clock position at 0 degree.

In cases where a TN liquid crystal display device whose rubbing directions have been set as shown in (a) of FIG. 8 is driven by a normally white mode by which a white display (bright display) is carried out when no voltage is applied, the absorption axis of the polarizing plate 541 facing the backlight 530 (such an absorption axis being hereinafter referred to as “back-polarizing-plate absorption axis”) is set to be oriented at angles of 135 degrees and 315 degrees in accordance with the (TFT-side) rubbing direction, and the absorption axis of the polarizing plate 542 facing a viewer (such an absorption axis being hereinafter referred to as “front-polarizing-plate absorption axis”) is set orthogonal to the back-polarizing-plate absorption axis.

In the case of such settings as described above, there is an increase in number of liquid crystal molecules, among those in the center of the liquid crystal layer, whose directors face six o'clock. It is this increase that causes a tone reversal region to be seen in the lower portion of the display screen from the six o'clock viewing angle.

It is preferable that such a TN liquid crystal display device as shown in (a) and (b) of FIG. 8 be applied as an in-vehicle multiview display device. This is because the multiview display device has its main viewing angle falling within a range of viewing angles of approximately twelve o'clock to three o'clock clockwise (range extending from the right side to the right oblique side=range of viewing angles on the driver's side, for example, in the case of a right-hand drive vehicle) or a range of viewing angles of approximately nine o'clock to twelve o'clock clockwise (range extending from the left side to the left oblique side=range of viewing angles on the passenger's side, for example, in the case of a right-hand drive vehicle) and the display screen will not be looked up at from below at the six o'clock viewing angle. Therefore, the settings shown in (a) and (b) of FIG. 8 are preferred so that the tone reversal region does not exert a bad influence on the viewability of the in-vehicle multiview display device.

Meanwhile, a TN liquid crystal display device as shown in (c) and (d) of FIG. 8 has a tone reversal region formed in the left portion of the display screen because one of the two rubbing directions orthogonal to each other and one of the two absorption axes orthogonal to each other are set parallel to the long axis of each of the lenses 504 (along a vertical direction in (c) and (d) of FIG. 8). Therefore, when applied as the in-vehicle multiview display device, the TN liquid crystal display device poses a problem for viewability.

For the reasons stated above, in the field of multiview display devices, such as the aforementioned in-vehicle multiview display device, which are not viewed from the six o'clock viewing angle, there has conventionally been a technical necessity in setting the polarization axis of each of the polarizing plates 541 and 542 so that the polarization axis of each of the polarizing plates 541 and 542 and the long axis of each of the lenses 504 have angles that are neither parallel nor orthogonal to each other. For this reason, the problem of contrast has actually been put on the back burner in this field.

### Solution to Problem

The present invention has been made in order to solve the foregoing problems, and it is an object of the present invention to provide: a liquid crystal display panel capable of presenting non-identical images along non-identical lines of sight with high contrast; and a display device including such a display panel.

In order to solve the foregoing problems, a liquid crystal panel according to the present invention is a liquid crystal display panel for displaying non-identical images along non-identical lines of sight, including: a parallax barrier having light-transmitting sections and light-blocking sections alternately arranged in a lattice manner with each of the light-transmitting sections provided with a condenser element having a long axis parallel to a long side of the light-transmitting section; and polarizing plates disposed on a light incidence side and a light exit side, respectively, each of the polarizing plates having its absorption axis set parallel or orthogonal to the long axis of the condenser element.

The inclusion of the parallax barrier in the foregoing configuration makes it possible to display non-identical images along non-identical lines of sight, thus making it possible to carry out a so-called multiview display, which shows different images to a plurality of viewers, or a so-called 3D display, which shows a stereoscopic image to a viewer who looks squarely at the liquid crystal display panel.

Further, since each of the light-transmitting sections is provided with a condenser element having a long axis parallel to a long side of the light-transmitting section, a bright multiview or 3D display can be carried out.

Meanwhile, a high-contrast liquid crystal display panel can display black without leakage of light by allowing arrival of linearly polarized light whose oscillating surface is parallel to the absorption axis of the polarizing plate disposed on the light exit side. That is, arrival of linearly polarized light or elliptically polarized light whose oscillating surface is not parallel to the absorption axis of the polarizing plate disposed on the light exit side causes the occurrence of a leaking-light component perpendicular to the absorption axis of the polarizing plate, thus rendering the black display (dark display) grayish.

According to the foregoing configuration of the present invention, however, since each of the polarizing plates has its absorption axis set parallel or orthogonal to the long axis of each condenser element of the parallax barrier, light passing through the condenser element is refracted by the condenser element but does not suffer a change in relationship between its direction of travel and its directions of oscillation. As a result, there is no change in relationship between the absorption axis of the polarizing plate disposed on the light exit side and the oscillating surface of the light, either.

Therefore, there occurs no leaking-light component that renders a black display (dark display) grayish. Accordingly, a bright, high-contrast multiview or 3D display can be realized.

Imagine rows and columns of pixel groups two-dimensionally arranged in a matrix manner with the columns orthogonal to the rows. Then, the arrangement of the light-transmitting sections and light-blocking section is not limited to a stripe manner in which column-wise light-transmitting sections and column-wise light-blocking sections are alternately arranged in rows, and a hound's-tooth manner in which light-transmitting sections and light-blocking sections are alternately arranged both in rows and columns is also encompassed in the foregoing configuration.

The liquid crystal display panel of the present invention is preferably configured such that the polarizing plates have their absorption axes set in a crossed Nicols manner, the liquid crystal display panel being in a normally white display mode.

The liquid crystal display panel of the present invention can use TN mode liquid crystals, electrically controlled birefringence mode liquid crystals, or the like and, since the polarizing plates have their absorption axes set in a crossed Nicols manner, can carry out a normally white mode display, i.e., carry out a white display (bright display) in the absence of a voltage applied to the liquid crystals.

In the normally white mode, a black display (dark display) is carried out by changing the alignment of liquid crystals through application of an on-voltage. For this reason, the normally white mode has such a problem that the influence of a residual phase difference and the like renders a black display (dark display) difficult (renders optimum optical compensation hard to attain), and as such, the normally white mode is vulnerable to the technical problem of the present application and causes a significant decrease in contrast.

Further, as compared with the normally black mode, which carries out a black display (dark display) in the absence of a voltage applied to the liquid crystals, the normally white mode can carry out a brighter display, thereby allowing a bright, high-contrast multiview or 3D display.

The liquid crystal display panel of the present invention is preferably configured to use electrically controlled birefringence mode liquid crystals.

This is because, as compared with TN mode liquid crystals, electrically controlled birefringence mode liquid crystals generate a smaller tone reversal region. This makes it possible to realize a high-contrast, wide-viewing-angle multiview or 3D display with satisfactory viewability.

The electrically controlled birefringence mode liquid crystal display panel the present invention further includes: a light incidence side substrate; a light exit side substrate; and a liquid crystal layer sandwiched between the substrates, wherein: a first rubbing direction of an alignment film provided on the light incidence side substrate is oriented within a range of angles of six o'clock to nine o'clock clockwise and a second rubbing direction of an alignment film provided on the light exit side substrate is oriented within a range of angles of twelve o'clock to three o'clock clockwise; or the first rubbing direction is oriented within a range of angles of three o'clock to six o'clock clockwise and the second rubbing direction is oriented within a range of angles of nine o'clock to twelve o'clock clockwise.

Thus, in cases where the first rubbing direction is oriented within the range of angles of six o'clock to nine o'clock clockwise and the second rubbing direction is oriented within the range of angles of twelve o'clock to three o'clock clockwise, a smaller tone reversal region appears in the range of angles of six o'clock to nine o'clock clockwise than in the case of TN mode liquid crystals.

Alternatively, in cases where the first rubbing direction is oriented within the range of angles of three o'clock to six o'clock clockwise and the second rubbing direction is oriented within the range of angles of nine o'clock to twelve o'clock clockwise, a smaller tone reversal region appears in the range of angles of three o'clock to six o'clock clockwise than in the case of TN mode liquid crystals.

Therefore, in either case, it is possible to realize a wide-viewing-angle multiview or 3D display.

For best display quality such as contrast and brightness, it is preferable that the first rubbing direction and the second rubbing direction be oriented opposite each other and be at an angle of 45 degrees to the two absorption axes, preferably, within the ranges of angels within which the first rubbing direction and the second rubbing direction are oriented.

The liquid crystal display panel of the present invention may be configured to be supplied with image display data that cancels a tone reversal for a display region where a tone reversal arises depending on viewing angles.

Because a display region where a tone reversal arises depending on viewing angles stays at the same position on the display screen, it is easy to create image display data in advance that cancels a tone reversal for a display region where a tone reversal arises. Thus, no matter what viewing angle the display screen is looked at from, the occurrence of a tone reversal is prevented. This makes it possible to realize a widest-viewing-angle multiview or 3D display with high contrast.

The liquid crystal display panel of the present invention can be configured to further include a main panel constituted by two substrates and a liquid crystal layer sandwiched between the two substrates, wherein the parallax barrier is provided on a light incidence side or light exit side of the main panel.

In the configuration in which the parallax barrier is provided on the light exit side of the main panel, two kinds of display light containing non-identical pieces of image information passes through the parallax barrier, and in the configuration in which the parallax barrier is provided on the light incidence side of the main panel, light from a light source such as a backlight passes through the parallax barrier, turns into two kinds of light along different lines of sight, and enter the main panel.

In any of the foregoing configurations, it is possible to display non-identical images along non-identical lines of sight.

A liquid crystal display device having such a liquid crystal display panel provided in a display section can be applied, for example, to an in-vehicle display that allows different images to be viewed from the driver's seat and the passenger seat, a large-screen display capable of showing different images to a plurality of viewer at the same time, a mobile device capable of a 3D display, etc. each of which can provide a high-contrast image display.

It should be noted that a combination of a configuration recited in a claim of interest and a configuration recited in another claim is not limited solely to a combination with a configuration recited in a claim depending from the claim of interest, but a combination with a configuration recited in a claim that is not dependent from the claim of interest is possible, provided such a combination can attain an object of the present invention.

Additional objects, features, and strengths of the present invention will be made clear by the description below. Further, the advantages of the present invention will be evident from the following explanation in reference to the drawings.

### Advantageous Effects of Invention

As described above, a liquid crystal panel according to the present invention is a liquid crystal display panel for displaying non-identical images along non-identical lines of sight, including: a parallax barrier having light-transmitting sections and light-blocking sections alternately arranged in a lattice manner with each of the light-transmitting sections provided with a condenser element having a long axis parallel to a long side of the light-transmitting section; and polarizing plates disposed on a light incidence side and a light exit side, respectively, each of the polarizing plates having its absorption axis set parallel or orthogonal to the long axis of the condenser element.

This prevents the occurrence of a leaking-light component that renders a black display (dark display) grayish, thus bringing about an effect of allowing realization of a bright, high-contrast multiview or 3D display.

### BRIEF DESCRIPTION OF DRAWINGS

FIG. 1(a)

FIG. 1(a) is a cross-sectional view schematically showing a configuration of a liquid crystal display panel of the present invention.

FIG. 1(b)

FIG. 1(b), showing a configuration of a liquid crystal display panel of the present invention, is an exploded perspective view concerning a first example configuration.

FIG. 1(c)

FIG. 1(c), showing a configuration of a liquid crystal display panel of the present invention, is an exploded perspective view concerning a second example configuration.

FIG. 2

FIG. 2 is an explanatory diagram showing a comparison between a configuration of the present invention and configurations of two kinds of conventional technology.

FIG. 3

FIG. 3 includes graphs (a) through (c) showing differences in contrast characteristic depending on differences in configuration among liquid crystal display panels, the graph (a) showing a contrast characteristic of a configuration of Conventional Technology (1), the graph (b) showing a contrast characteristic of a configuration of Conventional Technology (2), the graph (c) showing a contrast characteristic of a configuration of the present invention.

FIG. 4

FIG. 4 includes explanatory diagrams (a) and (b) for explaining the contrast characteristics of Conventional Technologies (1) and (2), the explanatory diagram (a) showing contrast characteristics along 0- and 180-degree azimuth lines as cut out from the contrast characteristics shown in (a) through (c) of FIG. 3, the explanatory diagram (b) showing a comparison between contrast ratios at polar angles of 30 degree and −30 degrees.

FIG. 5

FIG. 5 is an explanatory diagram showing the action of a condenser lens on light traveling through a liquid crystal display panel in the first example configuration shown in FIG. 1(b).

FIG. 6

FIG. 6 is an explanatory diagram showing the action of a condenser lens on light traveling through a liquid crystal display panel in the second example configuration shown in FIG. 1(c).

FIG. 7

FIG. 7 is an explanatory diagram showing the action of a condenser lens on light traveling through a liquid crystal display panel in an example configuration of a conventional technology.

FIG. 8 includes explanatory diagrams (a) through (h) showing how a tone reversal region is generated and a relationship of polarizing plates with the arrangement of absorption axes in a liquid crystal display panel that uses TN mode liquid crystals or ECB mode liquid crystals to carry out a normally white mode display, the explanatory diagrams (a) through (d) showing the case of use of the TN mode liquid crystals, the explanatory diagrams (e) through (h) showing the case of use of the ECB mode liquid crystals.

FIG. 9

FIG. 9 is an explanatory diagram showing a liquid crystal display panel from which tone reversal region has been eliminated by processing image display data.

FIG. 10(a)

FIG. 10(a) is a cross-sectional view schematically showing another configuration of a liquid crystal display panel of the present invention.

FIG. 10(b)

FIG. 10(b), showing another configuration of a liquid crystal display panel of the present invention, is an exploded perspective view concerning a third example configuration.

FIG. 10(c)

FIG. 10(c), showing another configuration of a liquid crystal display panel of the present invention, is an exploded perspective view concerning a fourth example configuration.

FIG. 11(a)

FIG. 11(a) is an explanatory diagram showing an example of arrangement of pixels (arrangement of colors of a color filter) in a liquid crystal display panel of the present invention.

FIG. 11(b)

FIG. 11(b) is a plan view showing an example of a light-blocking pattern of a parallax barrier of a liquid crystal display panel of the present invention.

FIG. 11(c)

FIG. 11(e) is an explanatory diagram showing a state of overlap between the arrangement shown in FIG. 11(a) and the light-blocking pattern shown in FIG. 11(b).

FIG. 12(a)

FIG. 12(a) is an explanatory diagram showing another example of arrangement of pixels (arrangement of colors of a color filter) of a liquid crystal display panel of the present invention.

FIG. 12(b)

FIG. 12(b) is a plan view showing another example of a light-blocking pattern of a parallax barrier of a liquid crystal display panel of the present invention.

FIG. 12(c)

FIG. 12(c) is an explanatory diagram showing a state of overlap between the arrangement shown in FIG. 12(a) and, the light-blocking pattern shown in FIG. 12(b).

FIG. 13

FIG. 13 is a cross-sectional view schematically showing a configuration of a liquid crystal display panel including a conventional parallax barrier including no condenser lenses.

FIG. 14

FIG. 14 is an explanatory diagram showing, according to a difference in width of each light-transmitting section, a comparison between the ways in which an image is separated into two directions by a parallax barrier.

FIG. 15

FIG. 15 is a cross-sectional view schematically showing a configuration of a liquid crystal display panel including a conventional parallax barrier including condenser lenses.

FIG. 16

FIG. 16 is an explanatory diagram showing how an image is separated into two directions by the parallax barrier shown in FIG. 15.

FIG. 17

FIG. 17 is an explanatory diagram showing a configuration in which an image is separated into three directions by a parallax barrier.

### DESCRIPTION OF EMBODIMENTS

### Embodiment 1

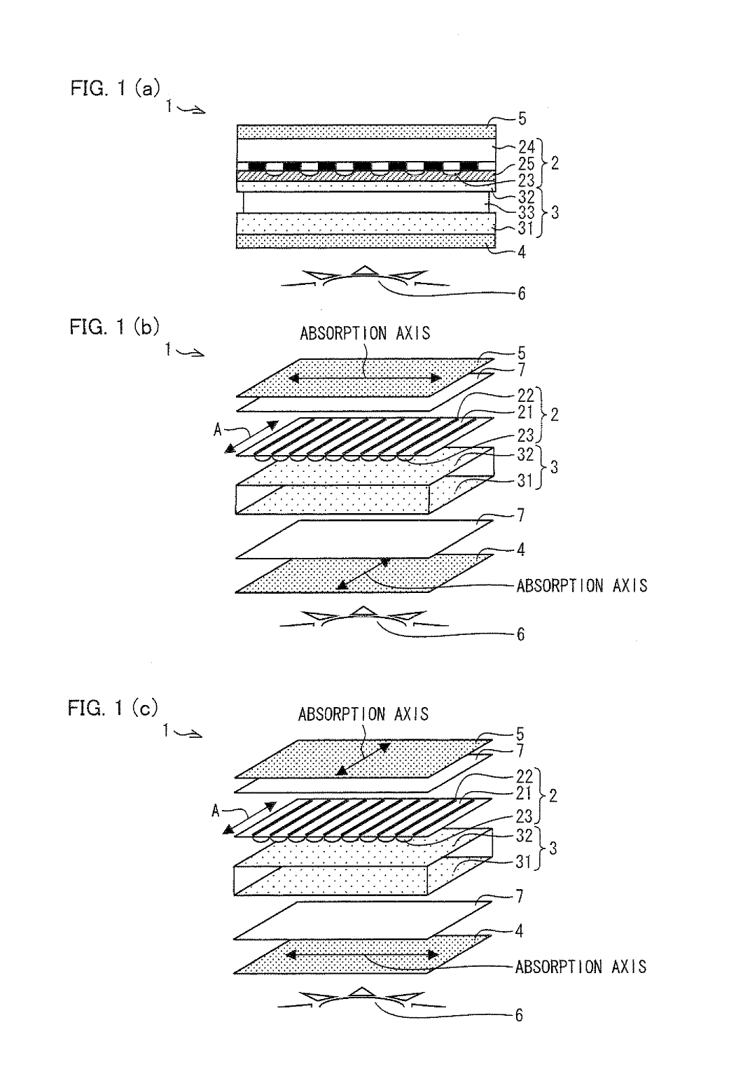

An embodiment of the present invention is described below with reference to FIGS. 1 through 7. For convenience of explanation, each of the drawings to which reference is made below shows a simplification of main components, among those making up an embodiment of the present invention, which are necessary for explaining the present invention. Therefore, a display device of the present invention can include a component that is not shown in any of the drawings to which this specification refers. Further, the dimensions of each component in each of the drawings are not a faithful representation of the actual dimensions of that component, the dimensional ratio of that component to another, etc.

(Main Components of a Liquid Crystal Display Panel)

As shown in FIG. 1(a), a liquid crystal display panel 1 according to the present invention includes: a parallax barrier 2, which plays a prominent role in displaying non-identical images along non-identical lines of sight; a main panel 3 constituted by two substrates and a liquid crystal layer sandwiched between the two substrates; a back polarizing plate 4 disposed on a light incidence side; a front polarizing plate 5 disposed on a light exit side; and a backlight 6, which serves as a display light source.

As schematically shown in FIGS. 1(b) and 1(c), the parallax barrier 2 has light-transmitting sections 21 and light-blocking sections 22 alternately arranged in a lattice manner, and each of the light-transmitting sections 21 is provided, for example, with a condenser lens 23 serving as a condenser element having a long axis parallel to a long side A of the light-transmitting section 21. A usable example of the condenser lens 23 is a semi-cylindrical lenticular lens whose convex surface has a predetermined curvature radius. Alternatively, it is possible to use, as the condenser element, a triangular prism having a long axis parallel to the long side A.

Further, each of the polarizing plates 4 and 5 has its absorption axis set parallel or orthogonal to the long axis of the condenser lens 23.

More specifically, in such a case as shown in FIGS. 1(b) and 1(c) where the polarizing plates 4 and 5 have their respective absorption axes disposed in a crossed Nicols manner, the polarizing plate 4 has its absorption axis parallel to the long axis of each condenser lens 23 as shown in FIG. 1(b), while the polarizing plate 5 has its absorption axis orthogonal to the long axis. Alternatively, the polarizing plate 4 has its absorption axis orthogonal to the long axis of each condenser lens 23 as shown in FIG. 1(c), while the polarizing plate 5 has its absorption axis parallel to the long axis.

The present invention can be embodied in any one of the forms described above. In particular, however, the configuration of FIG. 1(b) is preferable to the configuration of FIG. 1(c) in that the configuration of FIG. 1(b) allows a viewer wearing polarized sunglasses to view a display with no difficulty. That is, the configuration of FIG. 1(c) makes it difficult for a viewer wearing polarized sunglasses to view a display, because the polarized sunglasses cut linearly polarized light transmitted through the front polarizing plate 5.

In cases where the main panel 3 has TN mode liquid crystals or ECB (electrically controlled birefringence) mode liquid crystals, the polarizing plates 4 and 5 have their respective absorption axes disposed in a crossed Nicols manner when the main panel 3 is in a normally white display mode, while the polarizing plates 4 and 5 have their respective absorption axes disposed in a parallel Nicols manner when the main panel 3 is in a normally black display mode. The present invention can be applied to both the crossed Nicols and parallel Nicols arrangement of absorption axes.

It should be noted that disposed on a light incidence side and light exit side of the main panel 3 are optical compensation sheets 7, such as phase plates, which make it possible to control a polarized state and make various kinds of optical compensation, i.e., compensation for a viewing angle characteristic that effects a variation in gray scale, color, or contrast depending on viewing angles, compensation that widens a viewing angle, etc.

(Difference in Contrast Depending on the Orientation of Absorption Axes)

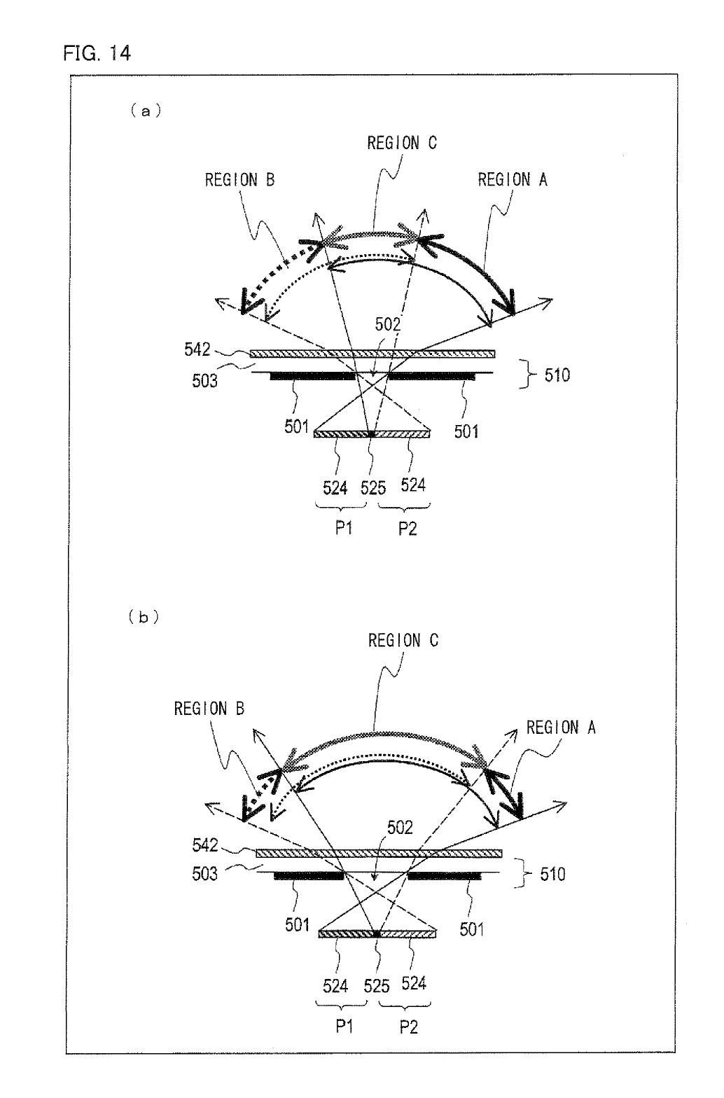

As in the above-described configuration whose principle has already been explained with reference to FIG. 14, the inclusion of the parallax barrier 2 by the liquid crystal display panel 1 makes it possible to display non-identical images along non-identical lines of sight, e.g., to realize a so-called multiview display, which shows different images to a viewer who looks at the liquid crystal display panel 1 from the direction of a right half extending clockwise from twelve o'clock to six o'clock and a viewer who looks at the liquid crystal display panel 1 from the direction of a left half extending clockwise from six o'clock twelve o'clock.

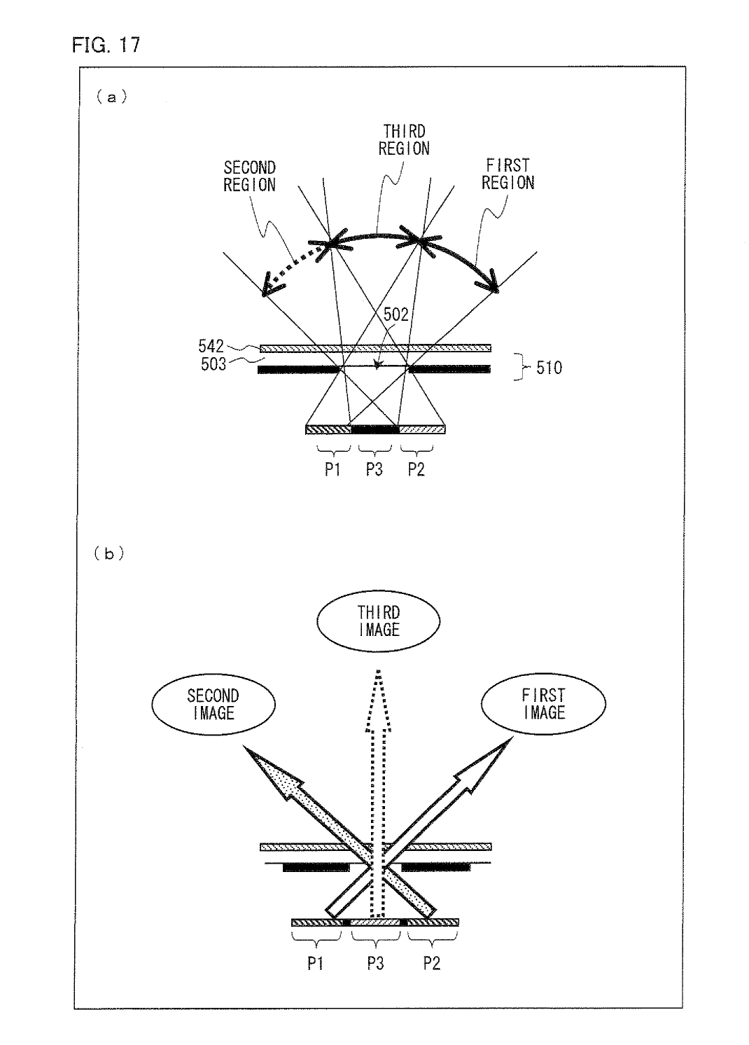

FIG. 17 shows an example configuration that realizes a three-direction multiview display, which displays non-identical images along three lines of sight different from one another. By disposing, between the pixels P1 and the pixels P2 in the configuration of FIG. 14, pixels P3 belonging to a third pixel group for displaying a third image, a third region for displaying the third image can be formed in front of each of the light-transmitting sections 502 of the parallax barrier element 510. The present invention can be applied to a configuration that realizes such a multiview display.

Further, by placing the parallax barrier 2 and the main panel 3 at a wider distance from each other than in the case of a multiview display, a so-called 3D display, which shows a stereoscopic image to a viewer who looks squarely at the liquid crystal display panel 1, can be carried out.

Further, since each of the light-transmitting sections 21 is provided with a condenser lens 23 having a long axis parallel to a long side A of the light-transmitting section 21, a bright multiview or 3D display can be carried out.

The following gives a look at an effect that is brought about when each of the polarizing plates 4 and 5 has its absorption axis set parallel or orthogonal to the long axis of each condenser lens 23.

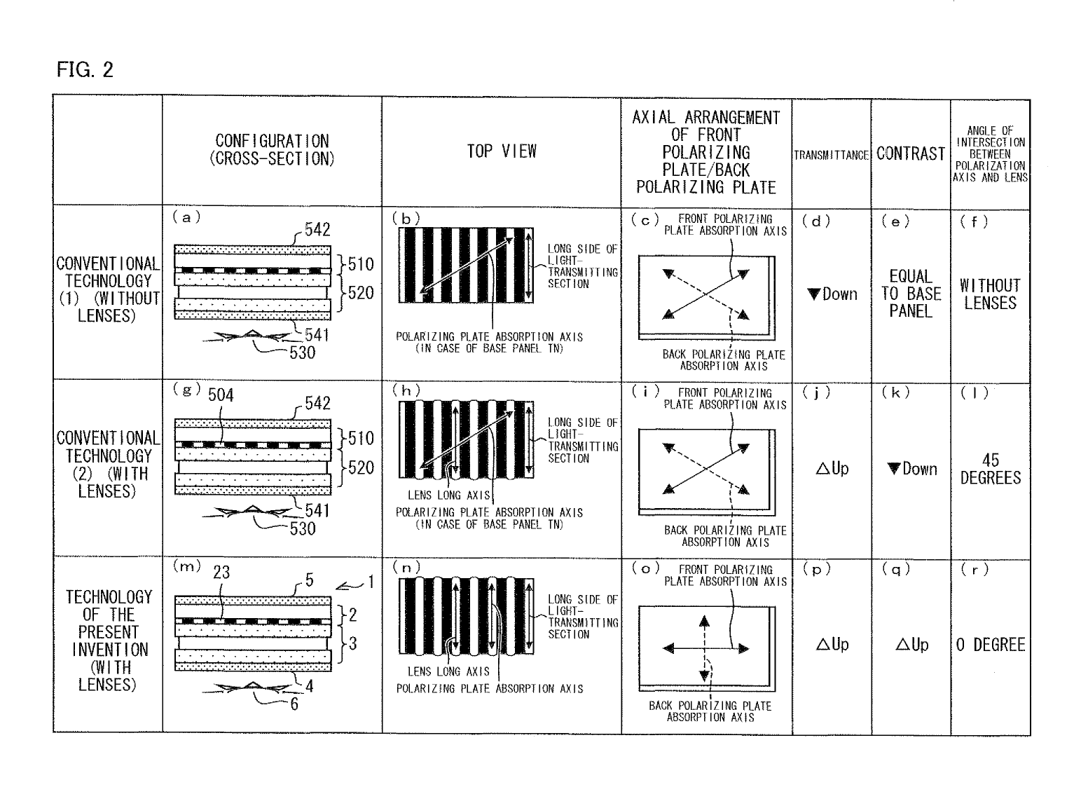

FIG. 2 shows a comparison of transmittance and contrast between conventional configurations and a configuration of the present invention.

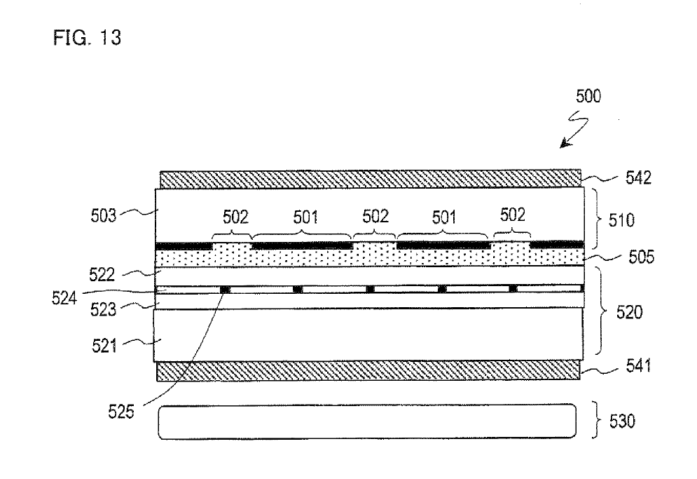

It should be noted that (a) through (f) of FIG. 2 relate to a conventional configuration (called “Conventional Technology (1)”) whose parallax barrier is provided with no condenser lenses, and the configuration has already been described with reference to FIG. 13.

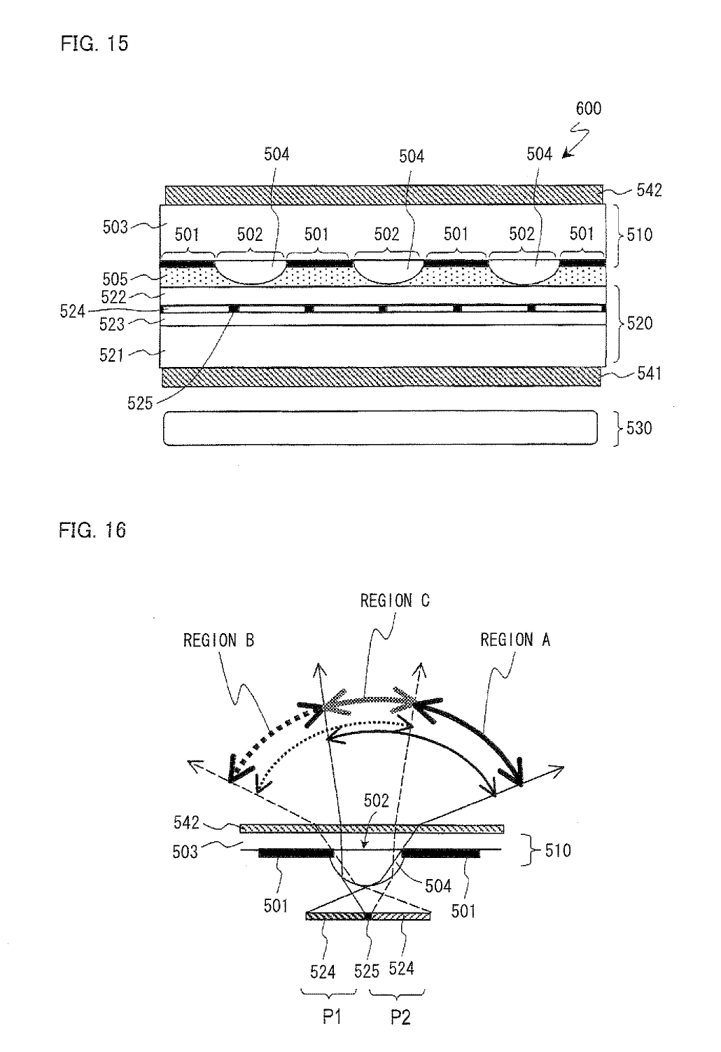

Further, (g) through (l) of FIG. 2 relate to a conventional configuration (called “Conventional Technology (2)”) whose parallax barrier is provided with condenser lenses, and the configuration has already been described with reference to FIG. 15.
Furthermore, (m) through (r) of FIG. 2 relate to a configuration of the present invention.

As shown in (b) and (c) of FIG. 2 and (h) and (i) of FIG. 2, both Conventional Technologies (1) and (2) are different from the configuration of the present invention in that each of their polarizing plates has its absorption axis inclined at an angle other than 0 degree or 90 degrees, e.g., at an angle of 45 degrees to a long side of each light-transmitting section of the parallax barrier.

As shown in (e), (k), and (q) of FIG. 2, the inclination of the absorption axis of each of the polarizing plates exerts an influence on display contrast. That is, in such a case as in Conventional Technology (1) where the parallax barrier is provided with no condenser lenses, the contrast is equal to the contrast of a liquid crystal display panel provided with no parallax barrier (base panel), whereas in such a case as in Conventional Technology (2) where the parallax barrier is provided with condenser lenses, the contrast is lower than the contrast of a base panel.

Moreover, in such a case as in the present invention where each of the polarizing plates has its absorption axis set parallel or orthogonal to the long axis of each condenser lens (long side of each light-transmitting section), the contrast is higher than the contrast of a base panel.

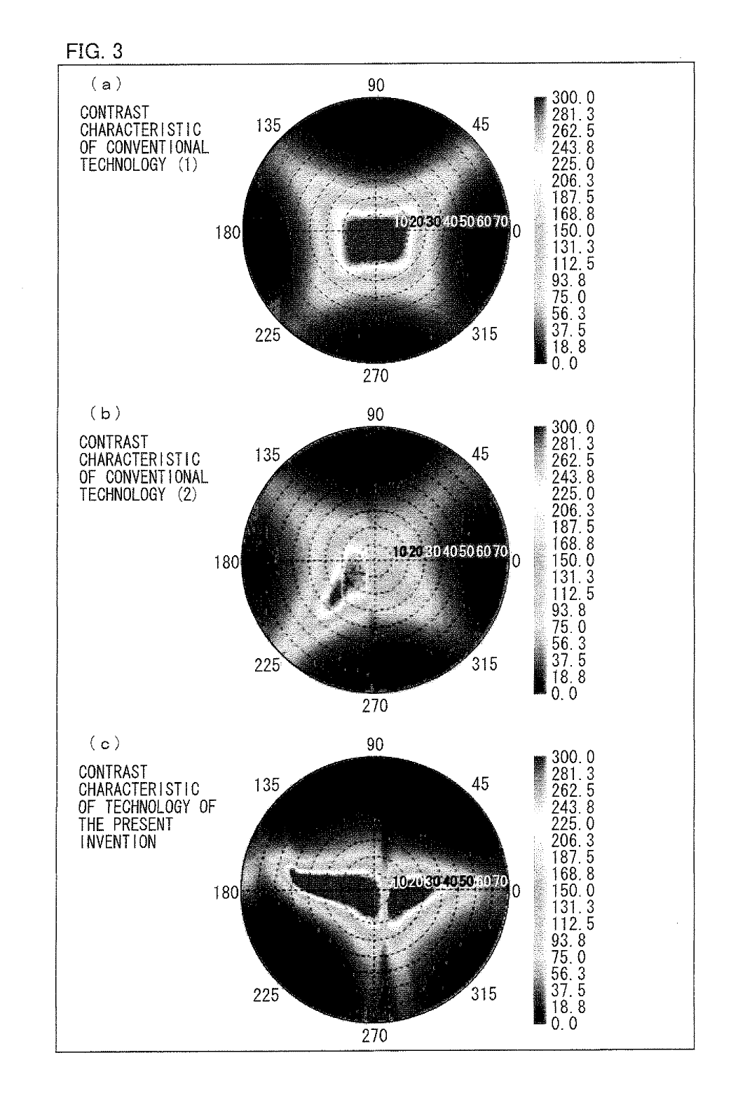

FIG. 3 shows results obtained by confirming the comparison of contrast by actual measurement. FIG. 3 shows contrast characteristics obtained by a luminance measuring device with respect to all directions from 0 degree to 360 degrees and a range of angles (polar angels) of 0 degree to 80 degrees to a line normal to the display panel. In FIG. 3, (a), (b), and (c) correspond to Conventional Technology (1), Conventional Technology (2), and the configuration of FIG. 1(b) of the present invention, respectively.

Each of (a) through (c) of FIG. 3 shows a circle having a high-colored region, located near the center of the circle, which indicates a highest-luminance region, and the luminance gradually decreases in any direction as it goes away from the high-colored region toward the outer circumference.

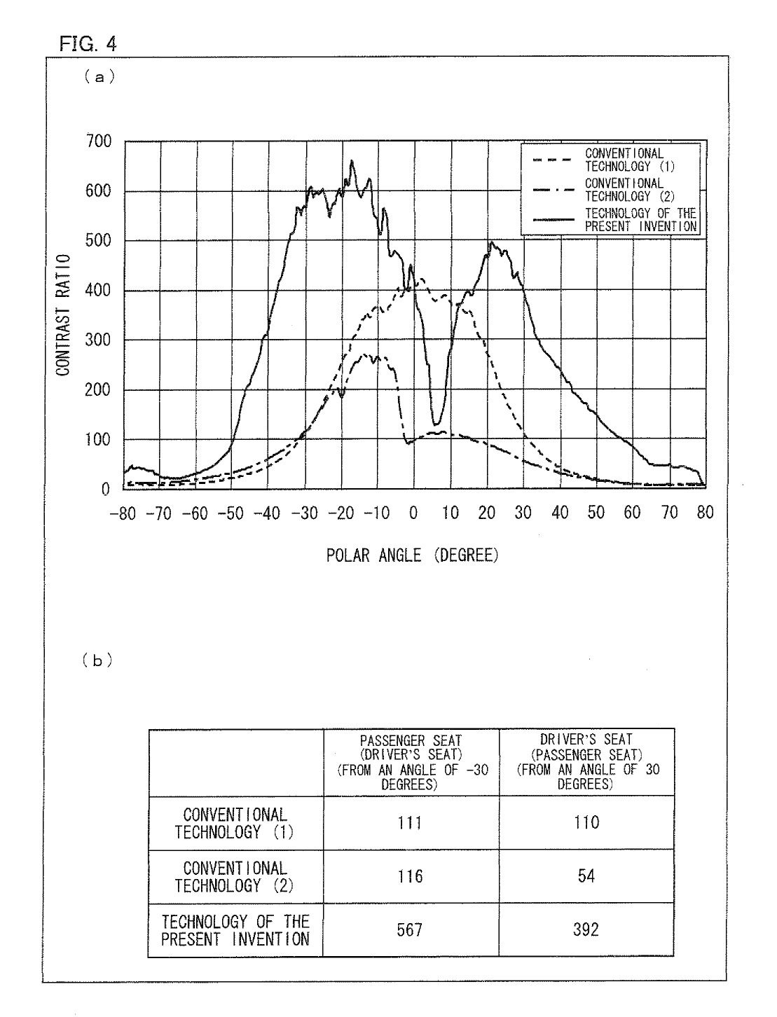

(a) of FIG. 4 shows a result obtained by normalizing and graphing luminance values at the respective polar angles along 0- and 180-degree azimuth lines among the measurement results of (a) through (c) of FIG. 3. According to (a) of FIG. 4, Conventional Technology (1) exhibits a symmetrical contrast characteristic as evidenced by (a) of FIG. 3. This result does not contradict the aforesaid statement that Conventional Technology (1) is equal in contrast to a base panel.

Meanwhile, Conventional Technology (2) is lower in contrast than Conventional Technology (1) at all polar angles as evidenced by (b) of FIG. 3. In particular, there is a significant drop in contrast in the direction of the right half extending clockwise from twelve o'clock to six o'clock.

On the other hand, the present invention exhibits peaks far exceeding the contrast of Conventional Technology (1) near polar angles 20 degrees to 30 degrees and −20 degrees to −30 degrees, although the present invention decreases in contrast when the liquid crystal display panel 1 is looked at from a polar angle of 0 degree, i.e., looked squarely at.

This result shows that the present invention is suitable for a multiview display device. This is because, for example, in the case of an in-vehicle multiview display device installed near a midsection between the driver's seat and passenger seat of a right-hand drive vehicle, the viewing angle from which the driver looks at the display screen is an angle of approximately 30 degrees to a line normal to the display screen, and the viewing angle from which a fellow passenger next to the driver looks at the display screen is an angle of −30 degrees to a line normal to the display screen.

Therefore, as shown in (b) of FIG. 4 by taking out the values at polar angles of 30 degrees and −30 degrees from (a) of FIG. 4, the present invention can provide high-contrast, clear images to both the driver and his/her fellow passenger.

On the other hand, the configuration of Conventional Technology (2), each of whose polarization axes is at an angle of 45 degrees to the long axis of each condenser lens, is very low in contrast at an polar angle of approximately 30 degrees and therefore results in a hard-to-view image.

By further optimizing an optical compensation system according to use (e.g., in the case of use in vehicle, viewing angles of approximately ±30 degrees as viewed from the front) for a liquid crystal display panel of the present invention with thus improved contrast, a viewing angle characteristic (such as the left-right symmetry of color characteristics) can be further bettered.

As for the overall transmittance, i.e., display brightness of each display panel, as shown in (d), (j), and (p) of FIG. 2, Conventional Technology (1) is lower in transmittance than a base panel because of the absence of condenser lenses and the presence of the parallax barrier, and Conventional Technology (2) and the present invention are higher in transmittance than a base panel because the condenser lenses contribute to an increase in luminance.

(Reason for an Increase in Contrast by a Configuration of the Present Invention)

The following explains why there is an increase in display contrast when each of the polarizing plates 4 and 5 has its absorption axis set parallel or orthogonal to the long axis of each condenser lens 23.

It should be noted that the following explanation assumes that the main panel 3 uses TN mode liquid crystals for example and is in a normally white display mode and a voltage is applied to the main panel 3 which causes the main panel 3 to carry out a black display (dark display).

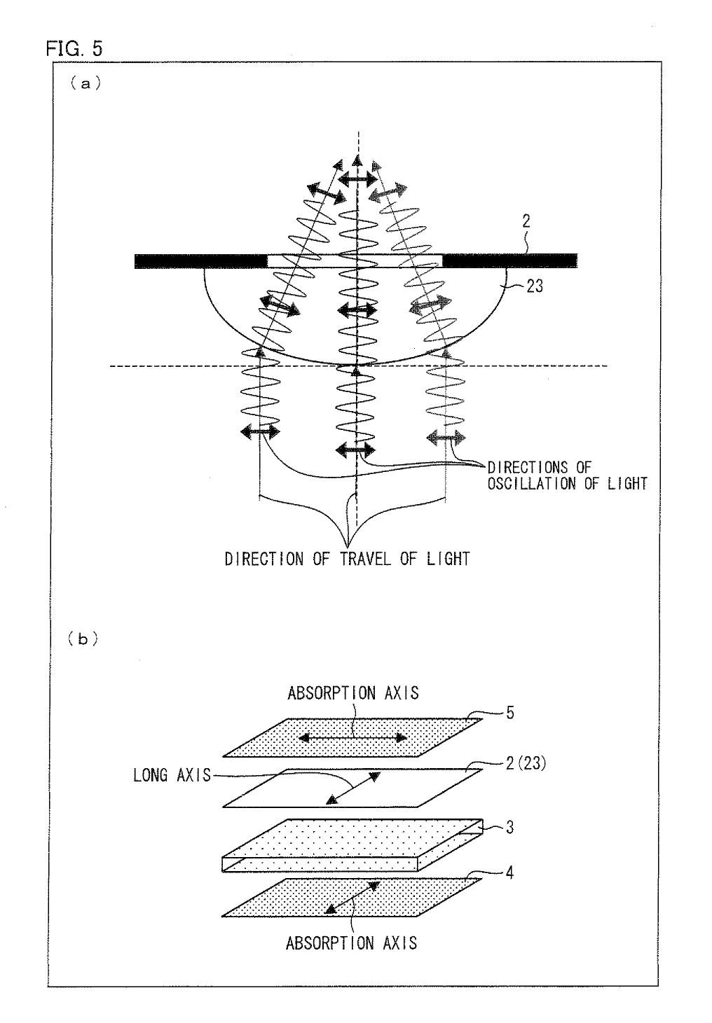

First, in such a case as shown in (b) of FIG. 5 where the absorption axis of the back polarizing plate 4 is parallel to the long axis of each condenser lens 23 and the absorption axis of the front polarizing plate 5 is orthogonal to the long axis, linearly polarized light having entered the main panel 3 through the back polarizing plate 4 passes through the main panel 3 without being influenced by birefringence and enters the condenser lens 23 while keeping its directions of oscillation. It should be noted here that the directions of oscillation of the light are parallel to the absorption axis of the front polarizing plate 5, i.e., orthogonal to the long axis of the condenser lens 23 as shown in (a) of FIG. 5.

In such a case where the directions of oscillation of light are orthogonal to the long axis of each condenser lens 23, light having entered the condenser lens 23 is refracted by the condenser lens 23 and suffers a change in its direction of travel, but does not suffer a change in its directions of oscillation. For this reason, light whose directions of oscillation are parallel to the absorption axis of the front polarizing plate 5 arrives at the front polarizing plate 5, and the front polarizing plate 5 therefore absorbs the light without leakage. This allows a satisfactory black display (dark display).

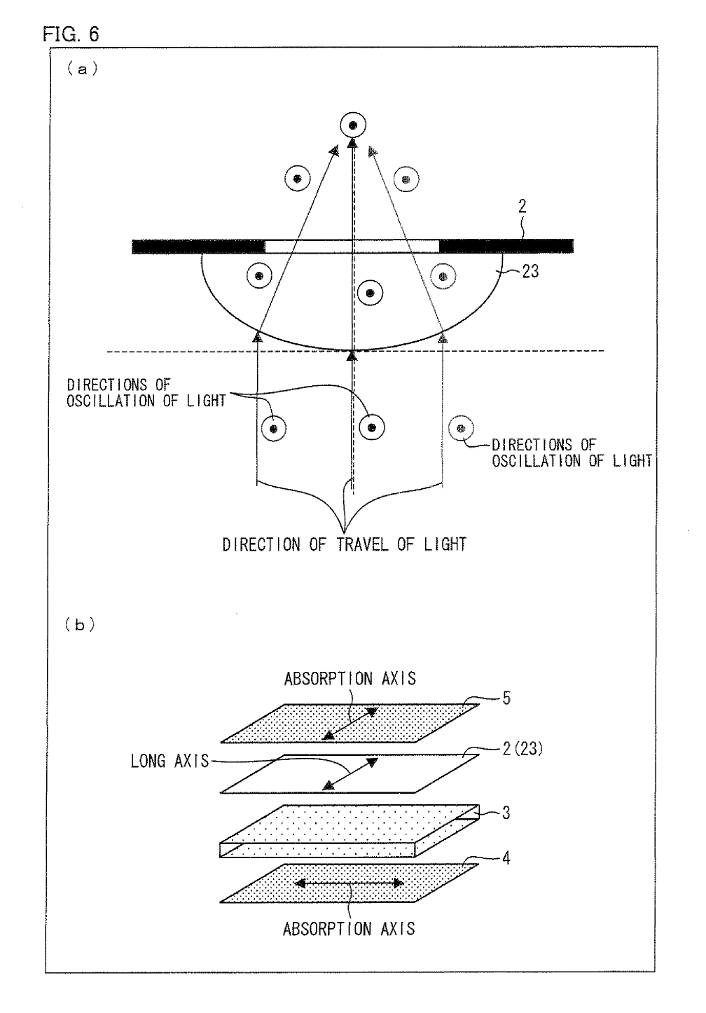

Further, in such a case as shown in (b) of FIG. 6 where the absorption axis of the back polarizing plate 4 is orthogonal to the long axis of each condenser lens 23 and the absorption axis of the front polarizing plate 5 is parallel to the long axis, linearly polarized light having entered the main panel 3 through the back polarizing plate 4 passes through the main panel 3 without being influenced by birefringence and enters the condenser lens 23 while keeping its directions of oscillation. It should be noted here that the directions of oscillation of the light are parallel to the absorption axis of the front polarizing plate 5, i.e., parallel to the long axis of the condenser lens 23 as shown in (a) of FIG. 6.

In such a case where the directions of oscillation of light are parallel to the long axis of each condenser lens 23, as in the above case, light having entered the condenser lens 23 is refracted by the condenser lens 23 and suffers a change in its direction of travel, but does not suffer a change in its directions of oscillation. For this reason, light whose directions of oscillation are parallel to the absorption axis of the front polarizing plate 5 arrives at the front polarizing plate 5, and the front polarizing plate 5 therefore absorbs the light without leakage. This allows a satisfactory black display (dark display).

The foregoing explanation shows that a satisfactory white display (bright display) is also allowed by applying no voltage to the main panel 3 to cause the main panel 3 to carry out a white display (bright display). The reason for this is as follows: The TN mode liquid crystals cause linearly polarized light to make a 90-degree turn in its directions of oscillation and the directions of oscillation therefore become parallel to the long axis of each condenser lens 23 in the configuration of (b) of FIG. 5 (as shown in (a) of FIG. 6) or orthogonal to the long axis of each condenser lens 23 in the configuration of (b) of FIG. 6 (as shown in (a) of FIG. 5); therefore, the light passes through the condenser lens 23 while keeping its directions of oscillation and is totally transmitted through the front polarizing plate 5.

Since both a black display (dark display) and a white display (bright display) are thus satisfactory, a high-contrast multiview or 3D display is allowed.

(Reason for a Decrease in Contrast by a Conventional Configuration)

The following explains why there is a decrease in display contrast when each absorption axis is inclined at an angle other than 0 degree or 90 degrees to the long axis of each condenser lens 23.

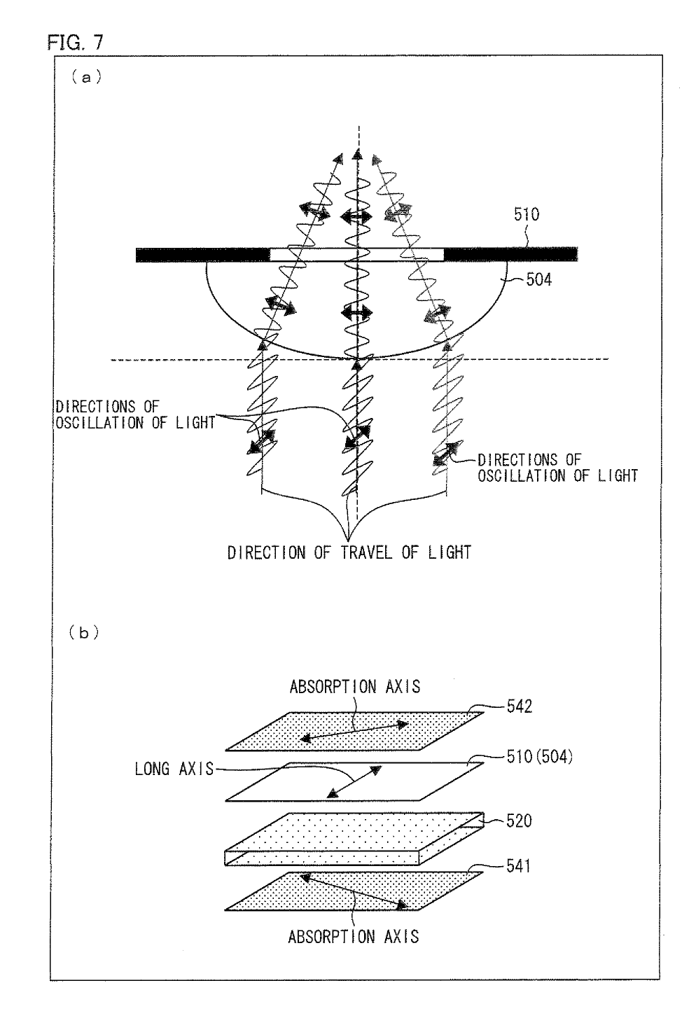

When, as shown in (b) of FIG. 7, each of the absorption axes, which are disposed in a crossed Nicols manner, of the back and front polarizing plates 541 and 542 has an angle of 45 degrees to the long axis of each condenser lens 504, linearly polarized light having entered the main panel 520 through the back polarizing plate 541 passes through the main panel 520 without being influenced by birefringence and enters the condenser lens 504 while keeping its directions of oscillation. It should be noted here that the directions of oscillation of the light are parallel to the absorption axis of the front polarizing plate 542 but, as shown in (a) of FIG. 7, has an angle of 45 degrees to the long axis of the condenser lens 504.

In such a case where the directions of oscillation of light have angles other than 0 degree or 90 degrees to the long axis of each condenser lens 504, light having entered the condenser lens 504 is refracted by the condenser lens 504 and therefore suffers changes both in its direction of travel and its directions of oscillation. For this reason, light whose directions of oscillation have angles that are not parallel to the absorption axis of the front polarizing plate 542 arrives at the front polarizing plate 542, and the front polarizing plate 5 therefore cannot absorb the light without leakage. That is, leakage of light from the front polarizing plate 542 leads to a grayish black display (dark display).

Also, in the case of a white display (bright display), the white display (bright display) ends up being grayish because the directions of oscillation of light to be transmitted through the front polarizing plate 542 have angles other than 0 degree or 90 degrees to the long axis of each condenser lens 504.

Since both a black display (dark display) and a white display (bright display) are grayish as above, there is a significant decrease in contrast.

(Supplementary Information to the Liquid Crystal Display Panel)

The foregoing has explained the main components of the present invention and their effects. The following gives supplementary information about other components of the liquid crystal display panel 1.

As shown in FIG. 1(a), the main panel 3 has an active matrix substrate 31 provided as its light incidence side, a CF substrate 32 provided as its light exit side, and a liquid crystal layer 33 sandwiched between the substrates 31 and 32. Formed on the active matrix substrate 31 are pixel electrodes, TFTs, etc., and formed on the CF substrate 32 are a color filter, a black matrix, a counter electrode, etc.

The parallax barrier 2 has its light-transmitting sections 21 and light-blocking sections formed by providing a patterned light-blocking layer on that surface of a transparent substrate (e.g., a glass substrate or a plastic substrate) 24 which faces the light incidence side.

Joining of the parallax barrier 2 to that surface of the CF substrate 32 which faces the light exit side is made by a resin layer 25 provided in such a way as to cover the condenser lenses 23. The resin layer 25, which is transparent, is formed, for example, by a UV cure adhesive, a visible light cure adhesive, or a thermosetting adhesive. In order to join the parallax barrier 2 to the main panel 3, the resin layer 25 is provided so that its thickness is greater than that of each condenser lens 23.

The backlight 6 may be a direct backlight or an edge-light backlight having a light guide plate. The backlight can employ various light sources such as cold-cathode tubes and light-emitting diodes.

The liquid crystal display panel 1 including such components as above can employ components adapted for various liquid crystal modes such as the ECB mode, the STN (super twisted nematic) mode, the IPS mode (in-plane switching) mode, and the VA mode (vertical alignment) mode, as well as the TN mode.

It should be additionally noted that a method for fabricating such a parallax barrier 2 including condenser lenses 23 is disclosed in Patent Literature 1 mentioned above.

### Embodiment 2

Another embodiment of the present invention is described below with reference to FIGS. 1, 8, and 9. For convenience of explanation, members having the same functions as those shown in the drawings of Embodiment 1 above are given the same reference numerals, and as such, are not described below.

The present embodiment configures the liquid crystal display panel 1 to carry out a normally white display in the ECB mode. The ECB mode is known as a system in which the inclination of liquid crystal molecules is changed by changing the voltage being applied to the liquid crystal layer and the resulting change in birefringence of the liquid crystal layer is detected by a pair of polarizing plates. More specifically, a halftone is displayed by converting linearly polarized light having entered through the back polarizing plate 4 into circularly polarized light or elliptically polarized light through the liquid crystal layer and phase plate to which a voltage has been applied, and a white display (bright display) or a black display (dark display) is carried out by controlling birefringence so that linearly polarized light whose directions of oscillation are orthogonal or parallel to the absorption axis of the front polarizing plate 5 arrives at the front polarizing plate 5.

It should be noted that although the ECB mode are classified into the PAN (parallel aligned nematic) system, the VAN (vertically aligned nematic) system, and the HAN (hybrid aligned nematic) system according to differences in molecular arrangement among liquid crystal cells used, the ECB mode may be any of the above.

The PAN system uses nematic liquid crystals whose dielectric anisotropy is negative, and the initial alignment of liquid crystal molecules is parallel to the substrate surfaces. The VAN system uses nematic liquid crystals whose dielectric anisotropy is positive, and the initial alignment of liquid crystal molecules is vertical to the substrate surfaces. The HAN system uses nematic liquid crystals whose dielectric anisotropy is negative or positive, and the initial alignment of liquid crystal molecules is parallel to one of the substrate surfaces and vertical to the other substrate surface, or vice versa.

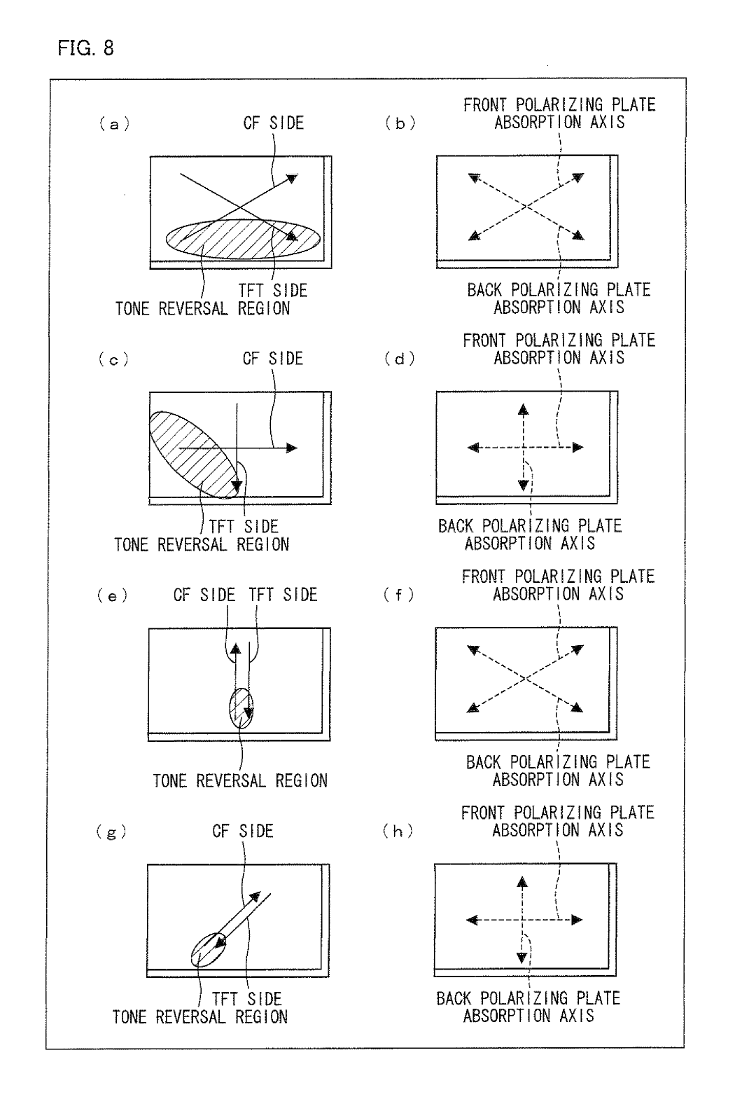

The back and front polarizing plates 4 and 5 take the same crossed Nicols form as shown in FIGS. 1(a) through 1(c) and (f) and (h) of FIG. 8 in which their respective absorption axes are orthogonal to each other.

The rubbing direction of an alignment film provided on the active matrix substrate 31 and the rubbing direction of an alignment film provided on the CF substrate 32 are opposite each other and each have an angle of 45 degrees to each of the absorption axes.

An ECB mode display has a feature of being smaller in tone reversal region as shown in (e) of FIG. 8 than a TN mode display. (e) of FIG. 8 shows an example configuration of a six o'clock viewing angle panel. That is, with the active matrix substrate 31 side rubbing direction oriented at 270 degrees the CF substrate 32 side rubbing direction oriented at 90 degrees, the absorption axis of the back polarizing plate 4 is set to be oriented at angles of 135 degrees and 315 degrees, while the absorption axis of the front polarizing plate 5 is set to be oriented at angles of 45 degrees and 225 degrees. Note, however, that the rubbing directions are indicated by angles that are larger than one another anticlockwise, with the three o'clock position at 0 degree.

In this case, a tone reversal region seen in the lower portion of the display screen from the six o'clock viewing angle is much smaller than in the TN mode.

A combination of this feature and such a feature of the present invention that each of the polarizing plates 4 and 5 has its absorption axis set parallel or orthogonal to the long axis of each condenser lens 23 causes a small tone reversal region to appear in a range of viewing angles of seven o'clock to eight o'clock completely out of a range of viewing angles of nine o'clock to twelve o'clock clockwise (range extending from the left side to the left oblique side), and as such, the combination is optimal for realizing a high-contrast, wide-viewing-angle multiview display.

In the configuration of (g) and (h) of FIG. 8, with the active matrix substrate 31 side rubbing direction oriented at 225 degrees the CF substrate 32 side rubbing direction oriented at 45 degrees, the absorption axis of the back polarizing plate 4 is set to be oriented at angles of 90 degrees and 270 degrees, while the absorption axis of the front polarizing plate 5 is set to be oriented at angles of 0 degrees and 180 degrees.

Such changes in the settings as below cause a small tone reversal region to appear in a range of viewing angles of four o'clock to five o'clock as opposed to (g) of FIG. 8, which are also optimal for realizing a high-contrast multiview display. That is, with the active matrix substrate 31 side rubbing direction oriented at 315 degrees the CF substrate 32 side rubbing direction oriented at 135 degrees, the absorption axis of the back polarizing plate 4 may be set to be oriented at angles of 0 degrees and 180 degrees, while the absorption axis of the front polarizing plate 5 may be set to be oriented at angles of 90 degrees and 270 degrees.

Furthermore, either in cases where the active matrix substrate 31 side rubbing direction (first rubbing direction) is oriented within a range of angles of six o'clock to nine o'clock clockwise and the CF substrate 32 side rubbing direction (second rubbing direction) is oriented within a range of angles of twelve o'clock to three o'clock clockwise, or in cases where the first rubbing direction is oriented within a range of angles of three o'clock to six o'clock clockwise and the second rubbing direction is oriented within a range of angles of nine o'clock to twelve o'clock clockwise, there appears a tone reversal region in the lower left or lower right portions of the display screen; therefore, there are no obstacles to a multiview display.

(Elimination of a Tone Reversal Region by Processing of Image Display Data)

A liquid crystal display panel where a tone reversal region arises depending on viewing angles, such as a liquid crystal display panel using the TN mode or the ECB mode, as described with reference to (a), (c), (e), and (g) of FIG. 8, may be supplied with image display data that cancels the tone reversal of such a tone reversal region.

A display region where a tone reversal arises depending on viewing angles stays at the same position on the display screen. For example, as shown in (c) of FIG. 8, a liquid crystal display panel which uses TN mode liquid crystals and each of whose polarizing plates has its absorption axis set in a parallel or orthogonal relationship with the long axis of each condenser element has a tone reversal region formed in the left portion of the display screen. As such, the liquid crystal display panel is supplied with image display data created in advance to cancel the tone reversal of the tone reversal region.

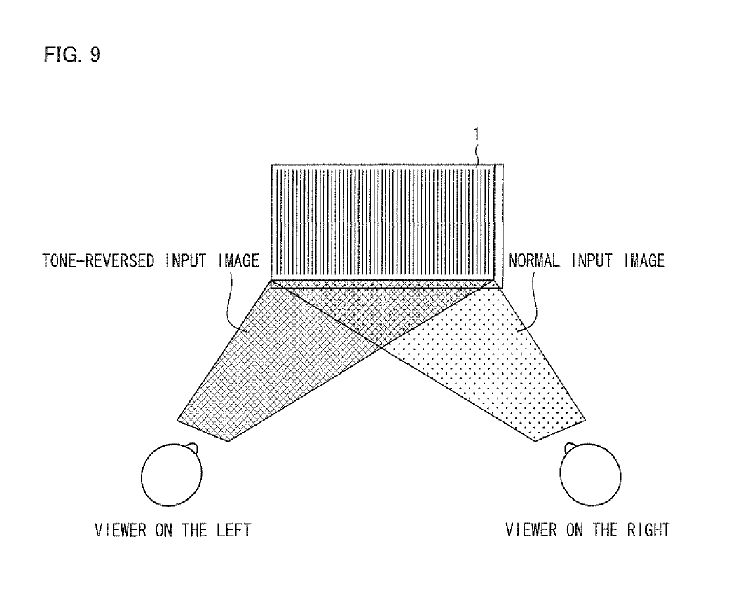

Thus, as shown in FIG. 9, a viewer who looks at the display screen of the liquid crystal display panel 1 on the left as the liquid crystal display panel 1 faces the viewer can view a correct first image free of tone reversal. Meanwhile, a viewer who looks at the display screen of the liquid crystal display panel 1 on the right as the liquid crystal display panel 1 faces the viewer can view a second image, created from normal image display data, which differs in content from the first image.

Thus, no matter what viewing angle the display screen is looked at from, the occurrence of a tone reversal is prevented. This makes it possible to realize a widest-viewing-angle multiview or 3D display with high contrast.

### Embodiment 3

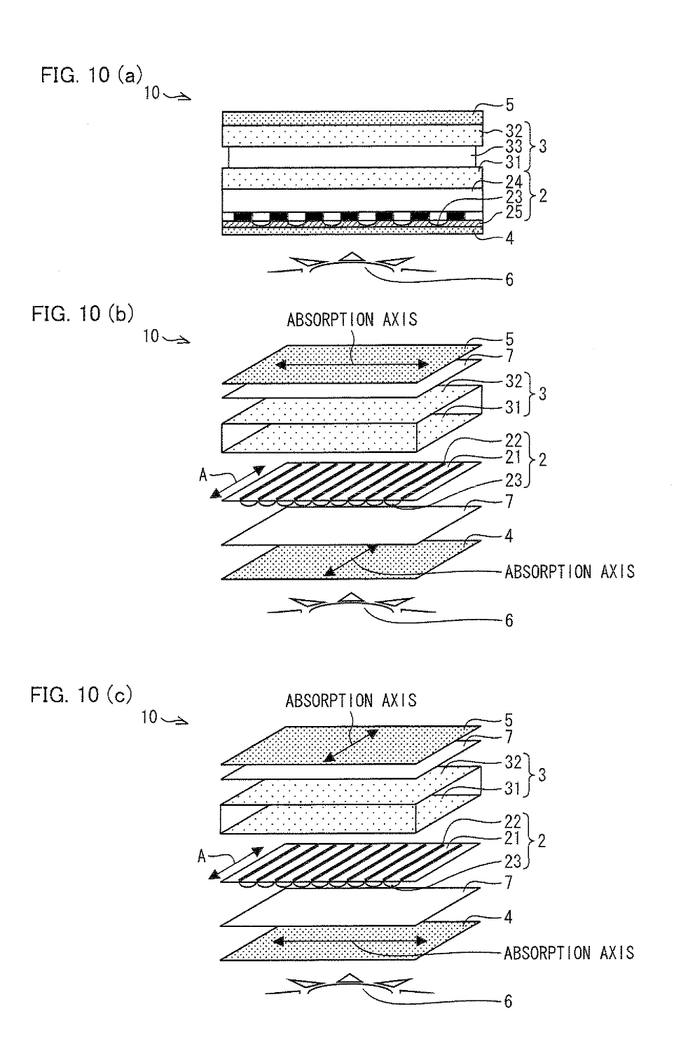

Still another embodiment of the present invention is described below with reference to FIG. 10. For convenience of explanation, members having the same functions as those shown in the drawings of Embodiment 1 above are given the same reference numerals, and as such, are not described below.

A liquid crystal display panel 10 of the present embodiment is different from the liquid crystal display panel 1 in that the parallax barrier 2 is provided on the light incidence side of the main panel 3. It should be noted that FIGS. 10 (b) and 10(c) are identical in configuration to FIGS. 1(b) and 1(c), respectively, except that the parallax barrier 2 is provided on the light incidence side of the main panel 3.

In the configuration in which the parallax barrier 2 is provided on the light incidence side of the main panel 3, light emitted from the backlight 6 passes through the parallax barrier 2 to enter the main panel 3 as two kinds of light along different lines of sight. That is, light emitted from the backlight 6 is separated into light that illuminates the first pixel group for displaying a first image and light that illuminates the second pixel group for displaying a second image.

This makes it possible to display non-identical images along non-identical lines of sight as in the configuration in which the parallax barrier 2 is provided on the light exit side of the main panel 3. Moreover, the feature of the present invention as previously explained makes it possible to realize a high-contrast multiview or 3D display.

### Embodiment 4

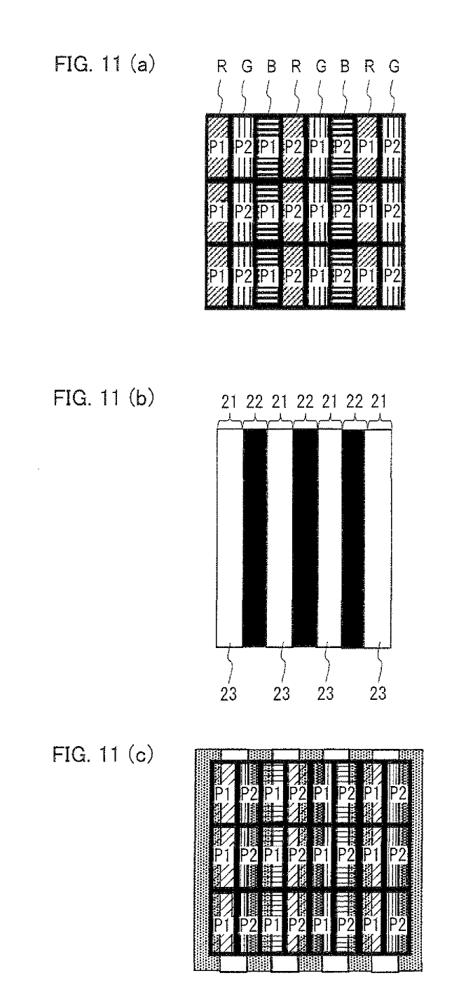

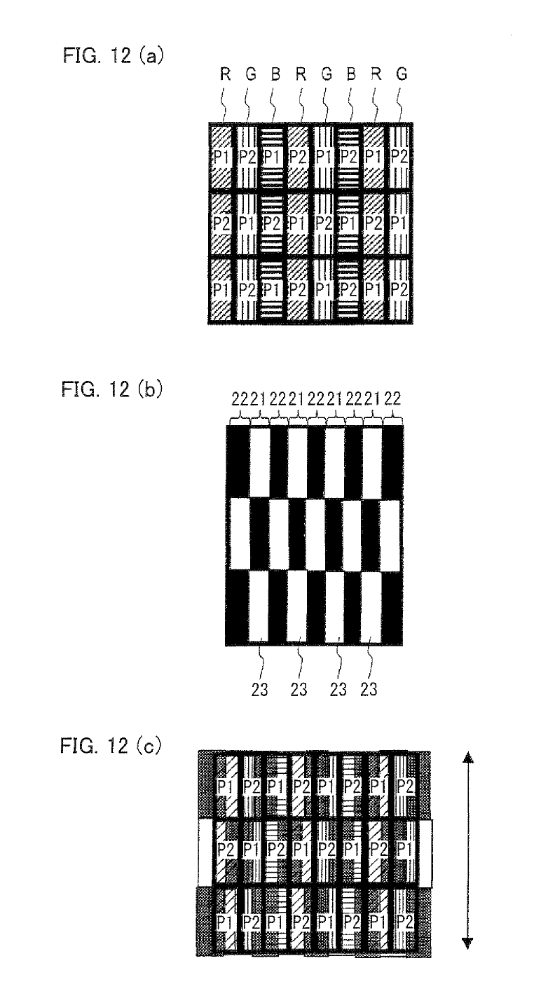

Still another embodiment of the present invention is described below with reference to FIGS. 11 and 12. For convenience of explanation, members having the same functions as those shown in the drawings of Embodiment 1 above are given the same reference numerals, and as such, are not described below.

The present embodiment explains the arrangement of pixels in each of the liquid crystal display panels 1 and 10 and an example of arrangement of light-blocking sections 22 of the parallax barrier 2.

FIGS. 11(a) through 11(c) show preferred examples of arrangement. FIG. 11(a) shows an arrangement of pixels in the main panel 3 (arrangement of colors of a color filter). FIG. 11(b) shows an arrangement of light-transmitting sections 21, light-blocking sections 22, and condenser lenses 23 of the parallax barrier 2. FIG. 11(c) shows a state of overlap between these arrangements.

In the example shown in FIG. 11(a), the plurality of pixels P1 belonging to the first pixel group and the plurality of pixels P2 belonging to the second pixel group are arranged in column-wise stripes, respectively, and the pixels P1 and P2 are alternately arranged in rows. In accordance with this arrangement of pixels, the plurality of light-transmitting sections 21, light-blocking sections 22, and condenser lenses 23 are also arranged in stripes as shown in FIG. 11(b) so that as shown in FIG. 11(c), the center line of each light-transmitting section 21 corresponds substantially with the boundary between a column of pixels P1 and a column of pixel P2 adjacent to each other.

FIGS. 12(a) through 12(c) show preferred examples of arrangement. In the example shown in FIG. 12(a), the pixels P1 and P2 are alternately arranged both in rows and columns. That is, the pixels P1 and P2 are arranged in a hound's tooth check pattern. In accordance with this arrangement of pixels, the plurality of light-transmitting sections 21, light-blocking sections 22, and condenser lenses 23 are also arranged in a hound's tooth check pattern as shown in FIG. 12(b) so that as shown in FIG. 12(c), the center line of each light-transmitting section 21 corresponds substantially with the boundary between pixels P1 and P2 adjacent to each other in a row.

Both the stripe arrangement shown in FIG. 11 and the hound's-tooth arrangement shown in FIG. 12 are encompassed in the scope of a parallax barrier for use in the present invention, i.e., “a parallax barrier having light-transmitting sections and light-blocking sections alternately arranged in a lattice manner with each of the light-transmitting sections provided with a condenser element having a long axis parallel to a long side of the light-transmitting section”. Use of the hound's-tooth arrangement shown in FIG. 12 places the pixels in a delta arrangement and therefore allows a finer image display.

However, use of the hound's-tooth arrangement, in which the light-transmitting sections 21 and the light-blocking sections 22 are alternately arranged not only in rows and but also in columns (as indicated by a two-headed arrow in FIG. 12(c)), causes an image to be separated not only into rows but also into columns. For this reason, for example, when a viewer looking squarely at a first image of a pixel P1 moves his/her head column-wise, he/she will end up viewing an image of a pixel P2 located right above or below the pixel P1. That is, use of the hound's-tooth arrangement places restrictions on a column-wise viewing range.

On the other hand, use of the stripe arrangement shown in FIG. 11 does not cause such a phenomenon and therefore does not place any restrictions on a column-wise viewing range.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be applied to: a liquid crystal display panel that displays non-identical images along non-identical lines of sight, e.g., that carries out a multiview display or a 3D display; and various liquid crystal display devices each having such a liquid crystal display panel provided in a display section.
REFERENCE SIGNS LIST
1 Liquid crystal display panel
2 Parallax barrier
3 Main panel
4 Back polarizing plate
5 Front polarizing plate
21 Light-transmitting section
22 Light-blocking section
23 Condenser lens (condenser element)
31 Active matrix substrate
32 CF substrate
A Long side

1. A liquid crystal display panel for displaying non-identical images along non-identical lines of sight, comprising:
a parallax barrier having light-transmitting sections and light-blocking sections alternately arranged in a lattice manner with each of the light-transmitting sections provided with a condenser element having a long axis parallel to a long side of the light-transmitting section; and
polarizing plates disposed on a light incidence side and a light exit side, respectively,
each of the polarizing plates having its absorption axis set in a parallel or orthogonal relationship with the long axis of the condenser element.

2. The liquid crystal display panel as set forth in claim 1, wherein the polarizing plates have their absorption axes set in a crossed Nicols manner, said liquid crystal display panel being in a normally white display mode.

3. The liquid crystal display panel as set forth in claim 1, said liquid crystal display panel using electrically controlled birefringence mode liquid crystals.

4. The liquid crystal display panel as set forth in claim 3, further comprising:
a light incidence side substrate;
a light exit side substrate; and
a liquid crystal layer sandwiched between the substrates, wherein:
a first rubbing direction of an alignment film provided on the light incidence side substrate is oriented within a range of angles of six o'clock to nine o'clock clockwise and a second rubbing direction of an alignment film provided on the light exit side substrate is oriented within a range of angles of twelve o'clock to three o'clock clockwise; or
the first rubbing direction is oriented within a range of angles of three o'clock to six o'clock clockwise and the second rubbing direction is oriented within a range of angles of nine o'clock to twelve o'clock clockwise.

5. The liquid crystal display panel as set forth in claim 1, said liquid crystal display panel being supplied with image display data that cancels a tone reversal for a display region where a tone reversal arises depending on viewing angles.

6. The liquid crystal display panel as set forth in claim 1, further comprising a main panel constituted by two substrates and a liquid crystal layer sandwiched between the two substrates, wherein the parallax barrier is provided on a light incidence side or light exit side of the main panel.

7. A liquid crystal display device comprising a liquid crystal display panel as set forth in claim 1 provided in a display section.
